(19) United States
(12) Patent Application Publication
(10) Pub. No.: US 2007/0151662 A1
(43) Pub. Date: Jul. 5, 2007

(54) Integrated process for simultaneous manufacture of oriented strand lumber and board products

(75) Inventors: Joel Barker, Townville, SC (US); Jianhua Pu, Bishop, GA (US); Feipeng Liu, Statham, GA (US); Kenneth Scott Chambers, Braselton, GA (US)

Correspondence Address: Huber Engineered Woods L.L.C.;c/o J.M. Huber Corporation, Law Department, 333 Thornall Street, Edison, NJ, 08837-2220, US

(73) Assignee: Huber Engineered Woods L.L.C., Charlotte, NC (US)

(21) Appl. No.: 11/315,228

(22) Filed: Dec. 23, 2005

(51) Int. Cl. B32B 37/00

(52) U.S. Cl. 156/256; 144/359

(57) ABSTRACT

The present disclosure is directed toward a process for the simultaneous production of two different types of engineered wood products, or oriented strand wood products, each product having different predetermined properties. The present disclosure provides a process which has enhanced utilization of wood resources and can simultaneously produce engineered wood product of various grades and properties from the same log source.

### BACKGROUND

1. Field of the Invention

The present teachings generally relate to a process for the simultaneous production of two different types of engineered wood products, or oriented strand wood products, each product having different predetermined properties. The present teachings provide a process which enhances utilization of wood resources and can simultaneously produce engineered wood products of various grades and properties from the same log source.

2. Discussion of the Related Art

Oriented strand board (“OSB”) and oriented strand lumber (“OSL”) have been widely used as structural components for roof, wall, and sub-flooring assemblies in residential and commercial applications.

OSB and OSL are commercially available from a number of companies including Huber Engineered Woods LLC, Georgia-Pacific Corporation, Louisiana-Pacific Corporation and a number of other sources. This material has multiple layers of wood “strands” or “flakes” bonded together by a binding material such as phenol-formaldehyde resin or isocyanate resin together with sizing agents such as paraffinic waxes. The strands are made by cutting thin slices with a knife edge parallel to the length of a debarked log. The strands are typically 0.01 to 0.05 inches thick, although thinner and thicker strands can be used in some applications, and are typically, less than one inch to several inches long and less than one inch to a few inches wide. The strands typically are longer than they are wide, with nominal aspect ratios (length:width) typically greater than about three. Strands are screened into different components and separated into storage bins. Strands sized less than about ⅛″, in general, are discarded and utilized as fuel. In general, up to about 95-98% of wood resource can be utilized for making OSB.

In the fabrication of oriented strand board, the strands are first dried to remove water, and are then coated with a thin layer of binder and sizing agent. The coated strands are then spread on a conveyor belt in a series of alternating layers, where one layer will have the strands oriented generally in line with the conveyor belt, and the succeeding layer of strands oriented generally perpendicular to the conveyor belt, such that alternating layers have strands oriented generally perpendicular to one another. The word “strand” is used to signify the cellulosic fibers which make up the wood, and, because the grain of the wood runs the length of the wood particle, the “strands” in the oriented strand board are oriented generally perpendicular to each other in alternating layers. The layers of oriented “strands” or “flakes” are finally subjected to heat and pressure to fuse the strands and binder together. The resulting product is then cut to size and shipped. Typically, the resin and sizing agent comprise less than 10% by weight of the oriented strand board product.

The OSL manufacturing process is substantially similar to the OSB manufacturing process but typically all the strands in usually thicker OSL product are oriented primarily in the machine direction.

The fabrication of engineered wood composite products including, for example, oriented strand board is described in, for instance, U.S. Pat. No. 5,525,394 to Clarke et al., and another detailed description of OSB manufacturing process can be found in Engineered Wood Products, A Guide for Specifiers, Designers, and Users (Edited by Stephen Smulski, 1997). Additional processes for producing engineered wood products, such as OSB and OSL, include those generally described in U.S. Pat. No. 4,061,819; Re. 30,636; U.S. Pat. Nos. 4,364,984; 4,610,913; 4,715,131; 5,096,765; 5,740,898; and 6,263,773 B1. Oriented strand board has been used as structural sheathing for walls, subfloors, roofs, and as web for wooden I-beams where strength, light weight, ease of nailing and dimensional stability under varying moisture conditions are important attributes. Oriented strand board is typically sold at a substantial discount compared to structural grades of soft plywood.

Increasingly scarce lumber resources and increased housing demand have placed demand on the construction industry to replace traditional timber log products with reconstituted engineered wood composite materials such as OSB, OSL and laminated strand lumber (“LSL”). Stronger and more durable wood-based products tailored to meet the specific performance requirements are also in demand. In many wood-based materials stiffness often turns out to be a limiting factor to designs. An important mechanical property of engineered wood composite components is the modulus of elasticity (“MOE”). Typically, for OSB panels, the MOE value is between about 0.45 to about 1.15 (mmpsi) along the major panel axis and is between about 0.08 to about 0.49 (mmpsi) across the major panel axis. For other engineered wood products, such as rim board, flanges of wooden I-joist, beams and headers, the typical MOE ranges from about 1.3 to about 1.9 (mmpsi).

Various manufacturing processes have been developed to address the increasingly scarce supply of lumber by utilizing juvenile logs to produce suitable alternatives. Those manufacturing processes include various lumber manipulation steps include screening and controlling the strand orientation by using longer and larger strands (U.S. Pat. Nos. 4,061,819; 4,610,913; 4,751,131, and 5,096,765), cutting the strands into uniform width for better alignment (U.S. Pat. No. 6,039,910), and thinner strands to manufacture high-performance oriented strand composites (Zhang, et al., J. Wood Sci., Vol. 44, pp. 191-197 (1998)).

Two-dimensional (“2D”) and three-dimensional (“3D”) log stranding have also been used to produce strands. A 2D stranding process controls both the length and the thickness of the strands produced. A 3D stranding process controls all three dimensions of length, thickness and width of the strands.

There is interest in increasing the percentage of wood fiber utilization for producing the engineered wood products. Generally, traditional solid sawn lumber only converts about 40% by weight of the wood fibers in the log into products. Laminated strand lumber utilizes as much as about 76% by weight of the wood fiber, while OSB is significantly higher with yields of about 94% by weight possible.

There are various factors affecting the utilization of raw lumber sources and processing those raw materials into engineered wood products. It is desirable to have processes which increase the usage of the raw wood material while still fulfilling engineering requirements of the final products.

### SUMMARY

The present teachings satisfy the need for a process for producing engineered wood products while utilizing a higher percentage of the wood resources.

The present teachings provide a process for the production of a first and a second oriented strand wood product by providing a log source, cutting the logs into strands with two or more independent stranding devices, and then screening the strands dependent on strand properties from each stranding device separately. The screened strands can then be directed from each stranding device, separately and dependent on the desired properties of the resulting oriented strand wood product, to a first production line and a second production line. The strands fulfilling a first property requirement can be directed, in some embodiments, simultaneously, to the first production line and the strands fulfilling a second property requirement to the second production line, respectively. Both the first and the second production lines can individually process, in some embodiments, simultaneously, the respective strands to form a first oriented strand wood product and a second oriented strand wood product, respectively.

The present teachings also provide a process for the production of engineered wood products having differing sets of physical properties by having the strand screening devices in communication with a plurality of engineered wood product processing lines.

Additionally, the present teachings further provide a production line for the production of a plurality, typically a first and a second, of engineered wood products. The production line can include two or more log stranding devices, two or more strand screening devices, and two or more strand processing lines, wherein each one of the two of more log stranding devices can be in separate communication with only one of the strand screening devices, and each one of the strand screening devices can be in communication with at least two of the strand processing lines.

### BRIEF DESCRIPTION OF THE FIGURES

The accompanying figures, which are included to provide a further understanding of the present teachings and are incorporated in and constitute a part of this specification, illustrate results obtained by various embodiments of the present teachings and together with the detailed description serve to explain the principles of the present teachings. In the figures:

FIG. 1 is a schematic of two embodiments of the process according to the present teachings with two strand screening devices each in communication with two strand processing lines.

### DETAILED DESCRIPTION

The present teachings relate to a process for the production of a first and a second oriented strand wood product including providing a log source, cutting the logs from the log source into strands with two or more independent stranding devices, and then screening the strands dependent on strand properties from each stranding device separately. The screened strands can then be directed, from each stranding device separately, to respective first and second production lines. Strands can be directed, in some embodiments, simultaneously, to the appropriate production line depending on the strand properties and the requirements of the final oriented strand wood product. The process according to the present teachings can further include processing the strands on both the first and second production lines to form a first oriented strand wood product and a second oriented strand wood product, respectively. The strand processing on the separate production lines can occur simultaneously.

According to another embodiment of the present teachings, a process for the production of engineered wood products includes providing a log source, cutting logs into strands in two or more independent stranding devices, and screening the strands dependent on strand properties from each stranding device separately. The screened strands are then distributed, from each stranding device separately and dependent on the desired properties of the resulting engineered wood products, strands to each of a plurality of engineered wood processing lines, typically both of a first and a second processing line. The strands are then processed on the respective processing lines to form the desired plurality of engineered wood products, typically, the engineered wood products include engineered wood products having differing sets of physical properties.

In the present process, logs from the log source are cut into 2D strands only, 3D strands only, or into a combination of 2D and 3D strands. Two-dimensional stranders, such as the Timberstrand® process, (from Trus Joist, A Weyerhaeuser Business of Boise, Id.), and 3D stranders, such as described in U.S. Pat. No. 6,035,910, can be used to produce strands suitable for the process of the present teachings. Inclusion of a 3D strander can provide flexibility with respect to the equipment on a production line. These 2D and 3D stranders can be custom built by various strander manufacturers, including, Pallmann Maschinenfabrik GmbH & Co. KG, Zweibrucken, Germany and Carmanah Design and Manufacturing Inc., Vancouver, British Columbia, Canada.

Strand properties used as a basis for screening the strands can include, for example, at least one member selected from the group consisting of length, width, thickness, density, moisture content, screen mesh size and modulus of elasticity. The parameters of the strand screening operation can be controlled to obtain the desired distributions of strand sizes. Dependent on the properties of the final products, the separation points for determining which strands are sent to a respective strand processing line can be set and changed as needed. For example, depending on the final products, the strands could be divided on the basis of length with, for example, strands longer than about 3 inches and shorter than about 4.5 inches sent to one strand processing line, and strands longer than about 4.5 inches and shorter than about 7 inches sent to another strand processing line. In another example of the present process, strands between about 2.5 inches and about 3.75 inches long and strands between about 4.75 inches and about 6.25 inches long can be sent to one strand processing line, and strands between about 3.75 inches and about 4.75 inches long can be sent to a different strand processing line.

After screening and distribution to their respective processing line, the strands are further processed according to the present teachings by applying a resin to the strands to form resinated strands, orienting the resinated strands into mats, and finishing the mats by application of heat and pressure into the respective oriented strand wood product having the desired properties.

The process can utilize various resins, including, without limitation, 4,4′-diphenylmethane-diisocyanate (“MDI”), melamine-urea-phenol-formaldehyde (“MUPF”), melamine-urea-formaldehyde (“MUF”), phenol-formaldehyde (“PF”), their copolymers, and mixtures thereof.

The resin can be any resin having properties sufficient to meet or exceed generally known standards for the desired grade of engineered wood product. For example, resins qualified for the manufacture of engineered wood products or structural composite lumber (“SCL”) products conforming to the applicable acceptance criteria as promulgated by building code authorities such as the International Code Council (“ICC”). Examples of such criteria include, for instance, the AC47 acceptance criteria for structural wood-based products. Further additional examples of acceptance criteria can be found at www.icc-es.org.

Additional compounds and additives, such as, for example, waxes, can be added during the resin addition process.

The process according to the present teachings can be utilized to produce oriented strand lumber products, oriented strand board products, and laminated strand lumber products. One of ordinary skill in the art can recognize various engineered wood products and processing techniques to which the present process can be applied.

While other more expensive log sources can be used in the process according to the present teachings, typically, the log source can be composed of relatively inexpensive logs of juvenile soft woods. According to the present teachings, the various embodiments of the process can have material usage yields ranging from about 76% to more than about 94%, which yield can be dependent on the mixture of OSB and OSL being produced from the raw material by the process.

Also provided by the present teachings is a production line for the production of a plurality of different engineered wood products including two or more log stranding devices, two or more strand screening devices, and two or more strand processing lines. Each one of the two of more log stranding devices can be in separate communication with only one of the screening devices, and each one of the strand screening devices can be in communication with at least two of the strand processing lines. Depending on the number and type of different engineered wood products to be produced on the production line according to the present teachings, the number of processing devices can be increased or decreased accordingly, and communication between the devices can also be adjusted accordingly.

Each of the two or more log stranding devices utilized in the production line can independently be either a 2D log strander or a 3D log strander. Use of a 3D strander can result in a higher portion of strands suitable for OSL product as opposed to OSB product, and the process according to the present teachings can be adjusted accordingly.

The production line can further include a resin application device, a strand orienting device, and a mat finishing device. The mat finishing device can be selected from, for example, a platen press with a mat preheater, a steam preheater and continuous mat press, an radio frequency (“RF”) preheater and multi-opening mat press, and a steam injection press alone without any mat preheater. Each of these additional devices is known to one of ordinary skill in the art and can be selected according to the desired properties of, and mix of engineered wood product to be produced by the present production line.

According to the present teachings, screened strands can be distributed to the respective processing lines to make engineered wood products with varying engineering requirements, such as MOE. Although shorter strands can generally not be used for making OSL products, these strands can be acceptable raw material for making OSB products, and the various embodiments of the present teachings provide processes to produce both OSB and OSL products from the same initial log supply by screening and distributing the strands to the appropriate processing line.

The present process can further include drying the strands before screening the strands. Drying the strands can occur in, for instance, a heated tumble dryer, a trip-pass dryer, or a drying tunnel. The tumble dryer can be a single-pass or multiple-pass dryer.

According to the present teachings, the criteria used as the basis for sorting the strands can include, for example, various strand properties, such as length, width, thickness, density, moisture content, screen mesh size and modulus of elasticity. The presently taught processes can utilize a variety of known methods for sorting strands including, for instance, those methods disclosed in U.S. Pat. Nos. 5,012,933; 5,109,988; and 6,234,322, EP1362643, EP1358020, EP1007227, EP0681895, WO2002/062493, and WO9840173. Additional sorting processes include the oscillating screen process and Quadradyn™ machine process both manufactured by PAL s.r.l. (Via delle Industrie, 6/B, 1-31047 Ponte di Piave (TV), Italy).

The various embodiments of the present teachings can be utilized to produce a variety of engineered wood product including oriented strand lumber, oriented strand board and laminated strand lumber. One of ordinary skill in the art will recognize that the present teachings are not limited to the named engineered wood products but can be utilized in any number of processes involving the processing of logs into strands, flakes, or any smaller wood particles and the sorting and selection of the strands, flakes, or smaller wood particles to produce engineered wood products.

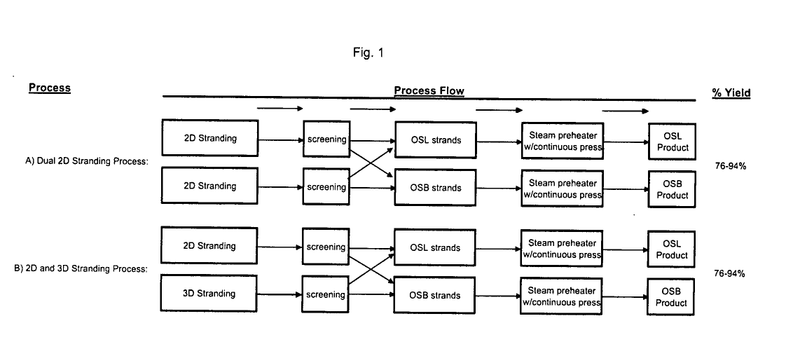

Two embodiments of the process and production line according to the present teachings are illustrated in FIG. 1. Process A utilizes two 2D stranders with the output of each strander feeding into its own strand screener. Each of the screeners then separates the strands and distributes a portion of the strands to the OSB process and another portion to the OSL process according to a predetermined selection property and selection range. The B process follows the same process steps as the A process with the exception that the B process utilizes one 2D strander and one 3D strander.

In other embodiments of the present teachings, both stranders can be 3D stranders, or the output from the strand screening process can be distributed to more than two processing lines. One of ordinary skill in the art will recognize numerous other process variations within the scope of the present teachings.

All publications, articles, papers, patents, patent publications, and other references cited herein are hereby incorporated herein in their entireties for all purposes.

Although the foregoing description is directed to various embodiments of the present teachings, it is noted that other variations and modifications will be apparent to those skilled in the art, and which may be made without departing from the spirit or scope of the present teachings.

### EXAMPLE

A supply of Aspen logs with diameters ranging from about 6 to about 12 inches was prepared for 3D stranding by being sawn into planks of about 1 inch wide. The planks were then stacked and fed into a ring strander to produce 3D strands. The strands were dried and were about 0.030 inch thick after drying.

The dried strands were then screened and classified into four different portions on the basis of screen mesh as follows: 1) 0.75 inch and above; 2) less than 0.75 inch and greater than 0.375 inch; 3) less than 0.375 inch and greater than 0.125 inch; and 4) less than 0.125 inch.

Two OSL and one OSB type products were prepared using a steam injection press from the classified strands and had the physical properties as set forth Table 1 below.

TABLE 1
OSL and OSB Products

| | Panel | 3D Furnish | Product | | |
|---|---|---|---|---|---|
| Potential | Layer | Clasification | Density | MOE (mmpsi) | |
| Product | Structure | screen mesh size | pcf | flatwise | edgewise |
| OSL | single | ¾″ above | 45.0 | N/A | 1.600 |
| OSL | single | ⅜″ to ¾″ | 38.7 | N/A | 1.314 |
| OSB | multiple | ⅛″ to ⅜″ | 41.0 | 0.779 | N/A |

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A process for the production of a first and a second oriented strand wood product comprising:
providing a log source;
cutting logs into strands with two or more independent stranding devices;
screening the strands dependent on strand properties from each stranding device separately;
directing simultaneously, from each stranding device separately and dependent on the desired properties of the resulting oriented strand wood product, strands fulfilling a first property requirement to a first production line, and strands fulfilling a second property requirement to a second production line; and
processing the strands on both the first and second production lines to form a first oriented strand wood product and a second oriented strand wood product, respectively.

2. The process according to claim 1, wherein the logs are cut into 2D strands only, 3D strands only, or into a combination of 2D and 3D strands.

3. The process according to claim 1, wherein the strand properties used as a basis for screening the strands comprise at least one member selected from the group consisting of length, width, thickness, density, moisture content, screen mesh size and modulus of elasticity.

4. The process according to claim 1, wherein the processing of the strands to form oriented strand wood products further comprises:
applying a resin to the strands to form resinated strands;
orienting the resinated strands into mats; and
finishing the mats into an oriented strand wood product having the desired properties.

5. The process according to claim 4, wherein the resin comprises at least one member selected from the group consisting of 4,4′-diphenylmethane-diisocyanate, melamine-urea-phenol-formaldehyde, melamine-urea-formaldehyde, phenol-formaldehyde, their copolymers and mixtures thereof.

6. The process according to claim 1, wherein the first oriented strand product comprises an oriented strand lumber product.

7. The process according to claim 1, wherein the second oriented strand product comprises an oriented strand board product.

8. The process according to claim 1, wherein the log source comprises juvenile soft woods.

9. A process for the production of engineered wood products comprising:
providing a log source;
cutting logs into strands in two or more independent stranding devices;
screening the strands dependent on strand properties from each stranding device separately;
distributing, from each stranding device separately and dependent on the desired properties of the resulting engineered wood products, strands to both a first and a second production line; and
processing the strands on both the first and second production lines to form a first engineered wood product and a second engineered wood product, respectively, and
wherein the engineered wood products comprise engineered wood products having differing sets of physical properties.

10. The process according to claim 9, wherein the logs are cut into 2D strands only, 3D strands only, or into a combination of 2D and 3D strands.

11. The process according to claim 9, wherein the strand properties used as a basis for screening the strands comprise at least one member selected from the group consisting of length, width, thickness, density, moisture content, screen mesh size and modulus of elasticity.

12. The process according to claim 9, wherein the processing of the strands to form engineered wood products further comprises:
applying a resin to the strands to form resinated strands;
orienting the resinated strands into mats; and
finishing the mats into an engineered wood product having the desired properties.

13. The process according to claim 12, wherein the resin comprises at least one member selected from the group consisting of 4,4′-diphenylmethane-diisocyanate, melamine-urea-phenol-formaldehyde, melamine-urea-formaldehyde, phenol-formaldehyde, their copolymers and mixtures thereof.

14. The process according to claim 9, wherein the desired properties of the resulting engineered wood product comprise at least one member selected from the group consisting of modulus of elasticity, edgewise modulus of elasticity, flatwise modulus of elasticity, modulus of rupture, surface characteristics, appearance, tension strength, shear strength and density.

15. The process according to claim 9, wherein the first engineered wood product comprises an oriented strand lumber product.

16. The process according to claim 9, wherein the second engineered wood product comprises an oriented strand board product.

17. The process according to claim 9, wherein the log source comprises juvenile soft woods.

18. A production line for the production of a first and a second engineered wood product comprising:
two or more log stranding devices;
two or more strand screening devices; and
two or more strand processing lines, and
wherein each one of the two of more log stranding devices is in separate communication with only one of the screening devices, and each one of the strand screening devices is in communication with at least two of the strand processing lines.

19. The production line according to claim 18, wherein the log stranding devices comprise either a 2D log strander or a 3D log strander.

20. The production line according to claim 18, wherein each of the strand processing lines further comprises:
a resin application device;
a strand orienting device; and
a mat finishing device.

21. The production line according to claim 20, wherein the mat finishing device comprises at least one member selected from the group consisting of a platen press with a mat preheater, a steam preheater and continuous mat press, a radio frequency preheater and multi-opening mat press, and a steam injection press without a mat preheater.
